(19) United States
(12) Patent Application Publication
(10) Pub. No.: US 2010/0122823 A1
(43) Pub. Date: May 20, 2010

(54) FOAM-GENERATING DEVICE OF A FIRE NOZZLE

(75) Inventor: Bruno GRANDPIERRE, Nogent Sur Siene (FR)

Correspondence Address: LOWE HAUPTMAN HAM & BERNER, LLP, 1700 DIAGONAL ROAD, SUITE 300, ALEXANDRIA, VA, 22314, US

(73) Assignee: POK S.A., Nogent Sur Seine (FR)

(21) Appl. No.: 12/620,793

(22) Filed: Nov. 18, 2009

(30) Foreign Application Priority Data
Nov. 18, 2008 (FR) 08/06450

(51) Int. Cl. A62C 31/02

(52) U.S. Cl. 169/15

(57) ABSTRACT

A fire nozzle foam-generator homogeneously expands a water/foam-forming agent and air premix. A nozzle spout is coaxial with a divergent cone having splines that generate divergent, strong, and separate jets of the premix that are incident on an internal surface of the nozzle spout where the jets merge to cause sucking of air towards the inside of the nozzle spout. As a result, the contact surface area between the air and premix increases, there is powerful mixing between the air and the premix, and an increase in to the range of the foam jet by progressive acceleration of the premix.

### RELATED APPLICATION

The present application is based on, and claims priority from, French Application Number 08/06450, filed Nov. 18, 2008, the disclosure of which is hereby incorporated by reference herein in its entirety.

### FIELD OF INVENTION

The present invention relates to the field of fire nozzles of the foam nozzle type. The present invention more particularly relates to a fire nozzle foam generator.

### BACKGROUND ART

A problem in the field of foam nozzles, e.g., nozzles (1) attached to fire hoses and (2) connected to fire prevention sprinkler systems, relates to the insufficiency and inhomogeneity of the expansion of a water/foam-forming agent and air premix before projection through the orifice of the nozzle spout.

Indeed, insufficiency and inhomogeneity of the expansion limit the efficiency of the foam in extinguishing the fire and the range of the foam jet.

Devices for projecting a water/foam-forming agent premix inside a tapered tube from a valve ensuring acceleration of the premix (see FIG. 7) are known in the prior art. Vents positioned between the valve and the tapered tube ensure contact of the outer surface of the premix jet with the outdoor air which is driven by viscosity inside the tapered tube. However, in this device, the premix only captures a small proportion of the air required for obtaining a well-expanded foam.

A modification of this device, as schematically illustrated in FIG. 8, includes an orifice at the center of the valve, connected to the outdoor air through a duct connected to the outside of the valve. This structure causes suction of outdoor air at the center of the premix jet and increases the contact surface area between the premix and the air, thereby doubling expansion. A drawback to this structure is that it is necessary to have an air feeding duct which, in a first phase, is perpendicular to the axis of the jet and then turns by 90° to bring the air to the center of the cone. As a result, the structure of FIG. 8 is complex, costly, and only allows the air to contact the interior surface of the premix jet.

In this context, it is interesting to propose a simpler and more efficient solution for (a) introducing air into the center of the premix crown, (b) to increasing expansion and (c) increasing the range of the foam jet.

An object of the present invention is to overcome these drawbacks of the prior art by providing a new and improved foam-generating device of a fire nozzle.

### SUMMARY OF THE INVENTION

This object is achieved, in accordance with a preferred embodiment, by a foam-generating device of a fire nozzle, comprising: a nozzle spout having a first end which is a first cylinder or a slightly convergent tube and a second end, and a divergent cone in and coaxial with the second end of the nozzle spout, wherein the second end of the nozzle spout includes air intakes. The divergent cone includes splines and is coaxially mounted in a second cylindrical tube. The tube and cone are arranged so the propagation front of a premix of water and foam-forming agent propagates in the cylindrical tube around the splined divergent cone to generate at an outlet of the second cylindrical tube, divergent, and separate jets of the premix The outlet of the second cylindrical tube is spaced from the first tube and air intakes are in an area of the second end of the nozzle spout located upstream from the outlet of the second cylindrical tube relative to the propagation direction of the premix to cause (a) the divergent and separate jets to be projected against the internal surface of the first tube and (b) the outdoor air to pass onto the outer surface of the jets and the outdoor air to pass between the jets. The divergence and separation of the jets cause outdoor air to be sucked towards the inside of the first tube on the one hand, and mixing between the air and the premix in the separation areas of the jets on the other hand. The jets merge upon encountering the internal surface of the first tube to produce a closed volume of premix into which outdoor air is sucked.

The second cylindrical tube is preferably maintained (a) on a longitudinal axis of the nozzle by radial spacers and (b) along the axis upstream from the first tube by a screw having (i) a head which blocks the orifice of the splined divergent cone and (ii) a threaded shaft which passes in the middle of radial spacers and penetrates into a tapped inner perimeter of the orifice of the splined divergent cone.

The second cylindrical tube is preferably coaxially fitted into the second end of the nozzle spout by a flush-fitting socket firmly secured to the outer perimeter of the second cylindrical tube.

A supporting ring, preferably coaxially mounted and firmly secured around the second cylindrical tube downstream from the flush socket and upstream from the first tube of the nozzle spout, preferably has an outer diameter slightly less than the inner diameter of the second end of the nozzle spout. The ring maintains the second cylindrical tube approximately on the nozzle axis, by abutting the internal wall of the second end, without preventing suction of outdoor air.

The splines of the divergent cone preferably have a section which increases in area at the same time as the section of the cone increases in area.

The thickness of the partitions forming the separation of the splines preferably determines the air penetration spaces and the homogeneity of the foam.

Other features and advantages of the present invention will become more clearly apparent upon reading the description hereafter, made with reference to the appended drawings.

### BRIEF DESCRIPTION OF THE DRAWING

FIG. 1 is a perspective view of a splined divergent cone included in a fire hose having a foam generator according to a preferred embodiment of the invention;

FIG. 2 is a longitudinal sectional view of a nozzle spout fitted with a foam-generator according to the preferred embodiment;

FIGS. 3 and 4 are transverse sectional views of the nozzle spout of FIG. 2 taken through the upstream and downstream lines B-B and A-A, respectively;

FIG. 5 is a perspective view of the nozzle spout with the foam generator removed so air intakes of the nozzle are clearly shown;

FIG. 6 is a perspective view of the nozzle spout fitted with the foam-generator;

FIG. 7 is a sectional view of a prior art device for projecting a water/foam-forming agent premix, as previously discussed;

FIG. 8 is a sectional view of a prior art device for projecting the water/foam-forming agent premix, as previously discussed; and

FIG. 9 is a schematic, sectional view of a preferred embodiment of the present invention.

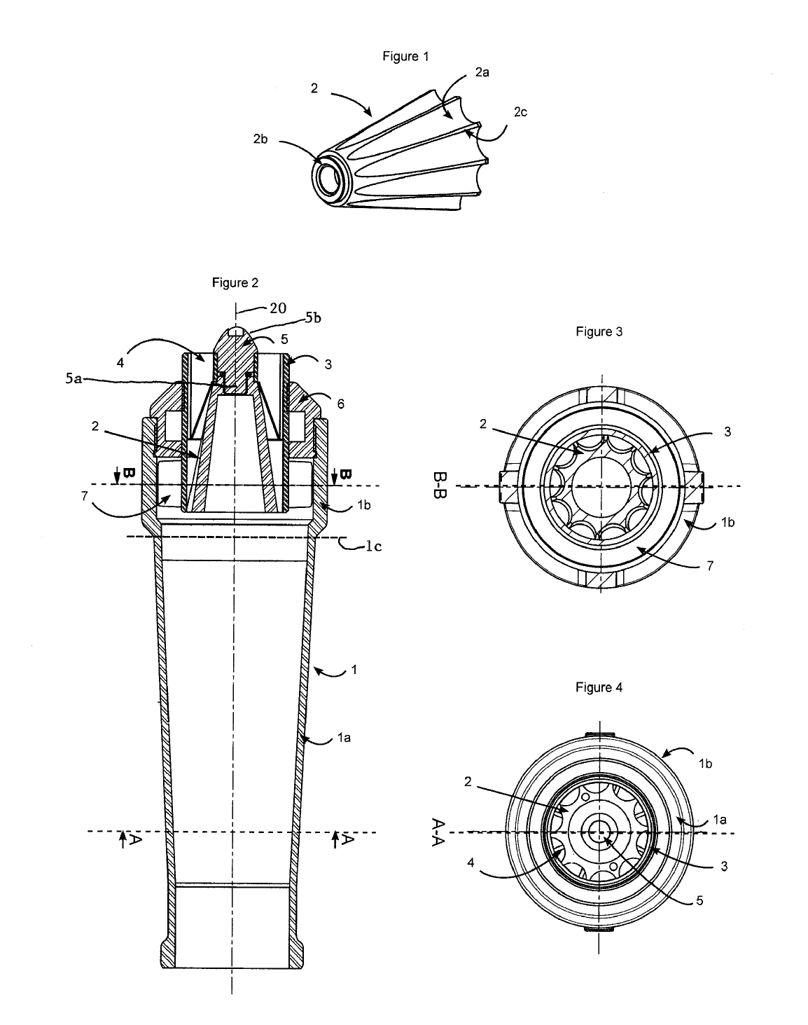

### DETAILED DESCRIPTION OF FIGS. 1-6 AND 9

The following description is not only made with reference to the figures, but also proposes following the propagation front of the premix from its entry into the foam-generating device up to its exit through the orifice of first tube (1a) of the nozzle spout (1), in order to clearly show the features and advantages of the structure of FIGS. 1-6 and 9.

The propagation front of the premix reaches the fire nozzle of FIG. 2 by means of a hose or pipe having an inner diameter equal to the outer diameter of a second cylindrical tube (3) slightly jutting out from the fire nozzle so the end of the hose or pipe can fit onto the perimeter of the second protruding cylindrical tube (3). Thus, the propagation front of the premix initially reaches the fire nozzle through a first end of the second cylindrical tube (3), as illustrated at the top of FIG. 2.

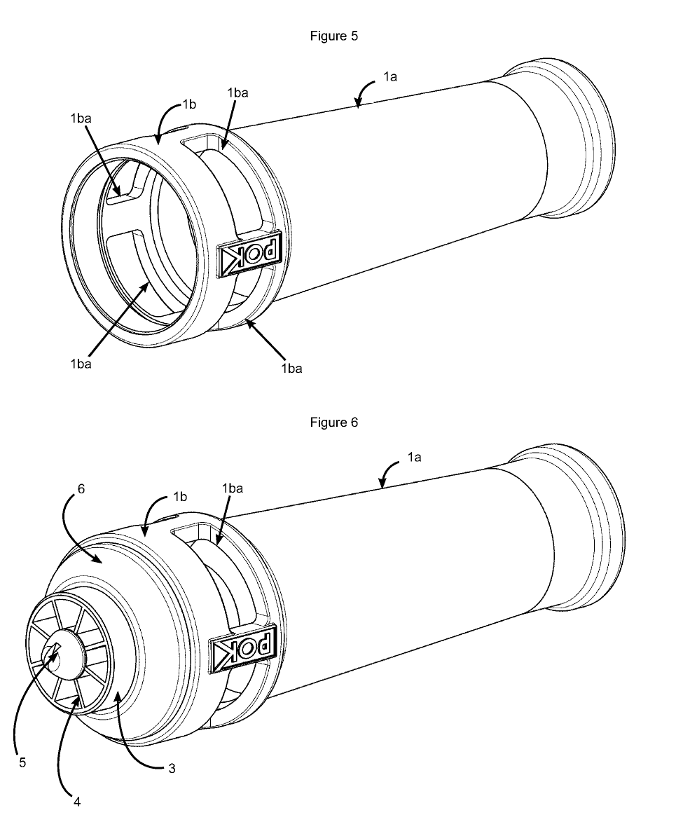

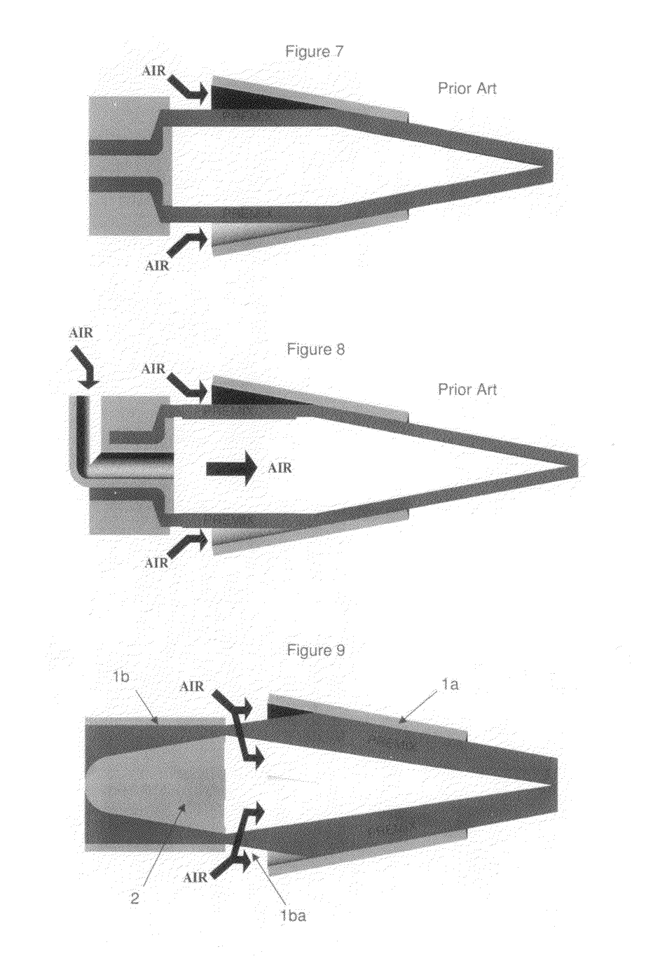

As seen from FIG. 6, the front propagates in the second cylindrical tube (3) through radially extending attached spacers (4) in the second cylindrical tube (3). The interior ends of spacers (4) terminate in a cylindrical area having the same longitudinal axis 20 as the second cylindrical tube (3) and nozzle spout (1). The cylindrical area has a smaller length and smaller radius than the length and radius of the second cylindrical tube (3), respectively. The length and radius of the cylindrical area are such that (a) threaded shaft 5a of screw (5) can pass through the cylindrical area, but (b) the head (5b) of screw (5) cannot pass through the cylindrical area. Thus, the front propagates in the second cylindrical tube (3) through radially extending spacers (4), and around screw (5), positioned on the axis of the second cylindrical tube (3), the head (5b) of which abuts against the interior ends of spacers (4) and the threaded shaft (5a) of which passes through the center of the radial spacers in order to reach the complementarily tapped inner perimeter of orifice (2b) of splined divergent cone (2). Spacers (4) and screw (5) maintain the splined divergent cone (2) on axis 20 inside second cylindrical tube (3). The interior ends of spacers (4) are nipped, from upstream to downstream of the propagation front, between head (5b) of screw (5) and orifice (2b) of splined divergent cone (2).

As seen from FIGS. 2 and 3, after passing between radial spacers (4) and around screw (5), the propagation front of the premix propagates into the second cylindrical tube (3) and around the divergent splined cone (2). Because of the divergence of the splined cone (2) (i.e., the outer surface of cone 2 tapers away from central axis 20 of nozzle spout (1) in the direction of longitudinal flow of the front), the available space for the flow of the premix in the second cylindrical tube (3) gradually decreases as the front propagates so there is less space at the outlet of second cylindrical tube (3) compared to the sole spaces delimited by the splines (2a) of the divergent cone (2). Thus, the foam generator of FIGS. 1-6 not only provides progressive acceleration of the premix, proportional to the power for ejecting the premix, but also produces divergent jets that are separated from each other.

Succinctly, as a result of the propagation of the front around the splined divergent cone (2), the propagation front at the outlet of the second cylindrical tube (3) (slightly below section line B-B in FIG. 2) consists of powerful, divergent jets that are separated from each other.

These premix jets are then projected onto the internal surface of first cylindrical or slightly convergent tube (1a) located at a first end of nozzle spout (1).

As illustrated in FIGS. 5 and 2, nozzle spout (1) includes a second end (1b) located upstream from the first tube (1a). End (1b) has suitable dimensions so that a firmly secured flush-fitting socket (6) is fitted therein. Socket (6) is seated approximately in the middle of the outer perimeter of the second cylindrical tube (3), so that the second cylindrical tube (3) has a length in the direction of axis 20 that is about one half the length of tube (3) in the direction of axis (20). Socket (6) is maintained at the center of the second end (1b) on axis 20 of the nozzle spout (1) and engages second end (1b) at a suitably selected location depending on the divergence of the jets leaving the second cylindrical tube (3); the jet divergence being closely related to the divergence of the splined cone (2).

The distance between the outlet of the second cylindrical tube (3) and the inlet of first tube (1a) of the nozzle spout (1) needs to be (a) sufficiently large to enable the flow of outdoor air from the air intakes (1ba) in the second end (1b) towards the inside of the first tube (1a) of the nozzle spout (1), and (b) sufficiently small so that the premix jets propagating from the second cylindrical tube (3) impinge on the internal surface of the first tube (1a) and not on the air intakes (1ba).

Thus, the powerful, separate divergent jets propagating from second cylindrical tube (3) and projected on the internal surface of the first tube (1a) (a) allow the outdoor air to pass on the outer surface of the jets by viscosity, (b) the outdoor air to pass between the separated jets, as far as the inside of the first tube (1a) of the nozzle spout (1), and (c) allow first mixing between the air and the premix in the separation areas of the jets. On the one hand, the sucking of outdoor air between the separated jets, as in the first tube (1a), occurs as a result of the divergence and separation of the jets. On the other hand, the suction effect is enhanced by merging of the jets as they encounter the internal surface of the first tube (1a) to generate a closed premix volume upstream from the orifice of the first tube (1a) of the nozzle spout (1), for example at plane (AA) illustrated in FIGS. 2 and 4.

Generation of a closed volume is further facilitated since the splines (2a) (FIG. 1) of the divergent cone (2) have a section which increases in area at the same time as the section of the cone (2) increases in area and the thickness of the partitions (2c) forming the separation of the splines determines the air penetration spaces and the homogeneity of the foam.

Because of the power of the pressure for projecting the premix into the hose and/or of the handling of the fire nozzle which changes the orientation of the nozzle spout (1) relative to the flexible hose, the device might be subject to non-negligible torsions at the flush-fitting socket (6) which may cause the second cylindrical tube (3) to be excessively spaced from axis 20 of the nozzle spout (1) as far as causing detachment or failure of the flush-fitting socket (6). To overcome this possibility and as illustrated in FIGS. 2 and 3, a supporting ring (7) having an outer diameter slightly less than the inner diameter of the second end (1b) of the nozzle spout (1) (cf. FIG. 3) is coaxially and securely mounted on the outer perimeter of the second cylindrical tube (3), between (a) the flush-fitting socket (6) located upstream and (b) the first tube (1a) of the nozzle spout (1) located downstream, so that ring 7 abuts the inner wall of the second end (1b) in the case of torsions to limit deformation of the flush-fitting socket (6). Supporting ring (7) is of suitable dimensions to fulfil this function without preventing suction of the outdoor air from the air intakes (1ba) in the second end (1b) of the nozzle spout (1).

The device of FIGS. 1-6 and 9 has two essential advantages as compared with the state of the art. The first advantage is to improve expansion by means of three phenomena which combine together:

(a) outdoor air is driven inside and outside the jets thereby doubling the contact surface area between the premix and the air,

(b) outdoor air passes into the separation areas of the jets to produce first mixing with the premix, and

(c) the seperate jets exiting splines (2a) merge on the inner surface of the first tube (1a) to provide powerful mixing between the air and the premix both inside and outside the premix jets.

The second advantage is to increase the range of the foam jet, and, by progressive acceleration related to a gradual reduction in the propagation space of the premix between the second cylindrical tube (3) and the splined divergent cone (2) on the one hand, and by improving (i.e., increasing) the foam jet the expansion on the other hand.

It should be obvious for the person skilled in the art that the present invention allows embodiments under many other specific forms without departing from the field of application of the invention as claimed. Therefore, the present embodiments should be considered as an illustration, but they may be modified in the field defined by the scope of the appended claims, and the invention should not be limited to the details given above.

1. A foam-generating device for a fire nozzle, comprising:
a nozzle spout having a first end which is a first cylindrical or slightly convergent tube and a second end,
a divergent cone coaxially posiioned in the second end of the nozzle spout, and
air intakes in the second end of the nozzle spout,
the divergent cone including splines and being coaxially mounted in a second cylindrical tube, the second cylindrical tube and the splined divergent cone being arranged to cause the propagation front of a premix of water and foam-forming agent to propagate in the second cylindrical tube, around the splined divergent cone, to generate at an outlet of the second cylindrical tube, divergent and separate jets of the premix, the outlet of the second cylindrical tube being spaced from the first tube and the air intakes being in an area of the second end of the nozzle spout located upstream from the outlet of the second cylindrical tube relative to the direction of propagation of the premix for causing (a) divergent and separate jets of the premix to be incident on an internal surface of the first tube so the separate jets merge on the internal surface of the first tube and (b) the outdoor air to pass on the outer surface of the jets and the outdoor air to pass between the jets, the divergence and separation of the jets causing (a) sucking of outdoor air towards the interior of the first tube on the one hand, and (b) mixing between the air and the premix in the separation area of the jets on the other hand; the merging of the jets on the internal surface of the first tube causing a closed premix volume into which outdoor air is sucked.

2. The device according to claim 1, wherein the second cylindrical tube is maintained on the axis by radially extending spacers and maintained along the axis upstream from the first tube by a screw, the screw having (a) a head for blocking an orifice of the splined divergent cone and (b) a threaded shaft which passes in the middle of the radially extending spacers and penetrates into a tapped inner perimeter of the orifice of the splined divergent cone.

3. The device according to claim 1, wherein the second cylindrical tube is coaxial with and held by the second end of the nozzle spout by a flush-fitting socket secured to the outer perimeter of the second cylindrical tube.

4. The device according to claim 1, wherein a supporting ring is coaxially mounted and secured around the second cylindrical tube downstream from the flush-fitting socket and upstream from the first tube of the nozzle spout, the ring having an outer diameter slightly less than the inner diameter of the second end of the nozzle spout to maintain the second cylindrical tube approximately on the axis, by abutting the internal wall of the second end, without preventing suction of the outdoor air.

5. The device according to claim 1, wherein the splines of the divergent cone have a section which increases in area at the same time as the section of the cone increases in area.

6. The device according to claim 1, wherein the thickness of the partitions forming the separation of the splines determines the air penetration spaces and the homogeneity of the foam.

7. The device according to claim 2, wherein the second cylindrical tube is coaxial with and held by the second end of the nozzle spout by a flush-fitting socket secured to the outer perimeter of the second cylindrical tube.

8. The device according to claim 2, wherein a supporting ring is coaxially mounted and secured around the second cylindrical tube downstream from the flush-fitting socket and upstream from the first tube of the nozzle spout, the ring having an outer diameter slightly less than the inner diameter of the second end of the nozzle spout to maintain the second cylindrical tube approximately on the axis, by abutting the internal wall of the second end, without preventing suction of the outdoor air.

9. The device according to claim 2, wherein the splines of the divergent cone have a section which increases in area at the same time as the section of the cone increases in area.

10. The device according to claim 2, wherein the thickness of the partitions forming the separation of the splines determines the air penetration spaces and the homogeneity of the foam.

11. The device according to claim 3, wherein a supporting ring is coaxially mounted and secured around the second cylindrical tube downstream from the flush-fitting socket and upstream from the first tube of the nozzle spout, the ring having an outer diameter slightly less than the inner diameter of the second end of the nozzle spout to maintain the second cylindrical tube approximately on the axis, by abutting the internal wall of the second end, without preventing suction of the outdoor air.

12. The device according to claim 3, wherein the splines of the divergent cone have a section which increases in area at the same time as the section of the cone increases in area.

13. The device according to claim 3, wherein the thickness of the partitions forming the separation of the splines determines the air penetration spaces and the homogeneity of the foam.

14. The device according to claim 4, wherein the splines of the divergent cone have a section which increases in area at the same time as the section of the cone increases in area.

15. The device according to claim 4, wherein the thickness of the partitions forming the separation of the splines determines the air penetration spaces and the homogeneity of the foam.

16. The device according to claim 5, wherein the thickness of the partitions forming the separation of the splines determines the air penetration spaces and the homogeneity of the foam.
